(19) United States
(12) Patent Application Publication
(10) Pub. No.: US 2026/0350988 A1
(43) Pub. Date: Nov. 5, 2026

(54) METHOD AND SYSTEM FOR DETECTING AND ACQUIRING MOTION INFORMATION OF BALL FROM FOOTBALL VIDEOS

(71) Applicant: SPOIT CO., LTD., lncheon (KR)

(72) Inventor: Jung Hyuk KWON, Seoul (KR)

(73) Assignee: SPOIT CO., LTD., lncheon (KR)

(21) Appl. No.: 19/117,989

(22) PCT Filed: Nov. 20, 2024
(86) PCT No.: PCT/KR2024/018317

§ 371 Date: Apr. 3, 2025

(30) Foreign Application Priority Data
Dec. 6, 2023 (KR) 10-2023-0175185

(51) Int. Cl. G06V 20/40; G06V 10/25; G06V 10/764

(52) U.S. Cl. CPC G06V 20/42; G06V 10/25; G06V 10/764

(57) ABSTRACT

sports video performed on a computing device may include the steps of searching for at least one object classified as a ball in an input sports image using an artificial intelligence model, classifying the input image as a key frame and determining the object as a ball if there is one object classified as the ball by the artificial intelligence model in the input image and a probability of the object being a ball is greater than or equal to a reference value, and determining an alternative region where a ball is expected to be located based on a location of a ball in a surrounding key frame if there is no object classified as the ball by the artificial intelligence model in the input image.

### TECHNICAL FIELD

The present invention relates to a method and system for detecting and acquiring motion information of a ball in football videos.

### BACKGROUND ART

The number of cases of applying ICT technology to sports videos is increasing. In particular, a technology for automatically extracting objects of interest from sports videos can provide various additional services. Object of interests are objects that a user is interested in in sports game videos, and may include a ball, a specific player, players belonging to a specific team, a score, etc. A video of a major event can be naturally generated by following an extracted ball with a camera for filming a sports game or enlarging and editing only a ball portion in an entire stadium video. Alternatively, a video of a specific player can be naturally generated by following a specific player with the camera for filming the sports game or enlarging and editing only a specific player portion in an entire stadium video. Alternatively, a heat map of a specific player can be created by automatically extracting motion information of specific players, or a game can be comprehensively analyzed by automatically extracting motion information of all players.

In particular, sports videos such as football videos or futsal videos have large stadium areas and wide regions covered by the filmed videos, and thus various additional services can be created by extracting only the portions that the user wants from the sports videos. For example, in order to extract a video of a specific player in action from football videos, the user should manually follow a specific player and edit the video, but if there is a technology to extract an object of interest, the technology can be applied to an original source of the sports video to automatically extract a video centered on the specific player. Alternatively, in football videos, the user should film sports videos by manually following a ball so that the ball does not deviate from a camera frame, but, likewise, if there is a technology to extract an object of interest, a desired sports broadcast video can be acquired by having the camera automatically follow the ball.

There are various methods for extracting an object of interest from an image. Representative methods for extracting the object of interest include methods that do not use machine learning and methods that use machine learning. Methods that do not use machine learning predefine the features of the object of interest and search for an object in the image based on the defined features. For example, if the object of interest is a ball, typical features of the ball (e.g., area occupied by the ball (number of pixels), curvature, color) may be predefined and the ball may be extracted based on such features. This method can be used in images with little noise and relatively clear images, but it has many errors, and errors can increase especially in videos that have a lot of motion of objects and are not static images, such as sports videos.

The method that uses machine learning is a method that learns the features of the object of interest in advance and finds the object of interest in an image using a trained model. You Only Look Once (YOLO) is a representative technology that extracts features based on a convolutional neural network (CNN) deep learning model and then uses the features to predict a type and location of an object. This machine learning-based object extraction method shows excellent performance, but since sports videos have many objects, there are many cases where the object of interest is obscured by other objects, and the method still shows incomplete performance.

### DISCLOSURE OF THE INVENTION

### Technical Problem

A method for searching a ball in football videos and generating motion information of the searched ball may be provided.

The technical problem to be solved by the present embodiment is not limited to the technical problem described above, and other technical problems may be inferred from the following embodiments.

### Technical Solution

A method for searching a ball in football videos and generating motion information of the searched ball may be provided.

The technical problem to be solved by the present embodiment is not limited to the technical problem described above, and other technical problems may be inferred from the following embodiments.

### Advantageous Effects

A method for searching a ball or a player in football videos and generating motion information of the searched object may be provided.

### BRIEF DESCRIPTION OF THE DRAWINGS

FIG. 1 illustrates a flowchart of a method for generating motion information of an object of interest in a sports video according to an embodiment.

FIG. 2 illustrates an original of a sports video according to an embodiment.

FIG. 3 illustrates a flowchart of a method for preprocessing a sports video according to an embodiment.

FIG. 4 illustrates a state in which an object of interest is searched in a sports video according to an embodiment.

FIG. 5 illustrates an original of a sports video according to an embodiment.

FIG. 6 illustrates a two-dimensional sports stadium according to an embodiment.

FIG. 7 illustrates an analysis result generated based on location information of an object of interest according to an embodiment.

FIG. 8 illustrates a heatmap generated based on location information of an object of interest according to an embodiment.

FIG. 9 illustrates a flowchart of a method for acquiring location information of an object of interest according to an embodiment.

FIG. 10 illustrates a state in which an object of interest is searched in a sports video according to an embodiment.

FIG. 11 illustrates a state in which a ball is not searched in a sports video according to an embodiment.

FIG. 12 illustrates a current frame and surrounding frames in a sports video according to an embodiment.

FIG. 13 illustrates a current frame and surrounding frames in a sports image according to an embodiment.

FIG. 14 illustrates motion of an object of interest in a sports video according to an embodiment.

FIG. 15 illustrates motion of an object of interest in a sports video according to an embodiment.

FIG. 16 illustrates a state in which a plurality of balls are searched in a sports video according to an embodiment.

FIG. 17 illustrates a candidate region of an object of interest in a sports video according to an embodiment.

FIGS. 18a and 18b illustrate labeled objects of interest according to an embodiment.

FIG. 19 illustrates a flowchart of a method for performing labeling on an object of interest according to an embodiment.

FIG. 20 illustrates a state in which tracking of a labeled object of interest fails according to an embodiment.

FIG. 21 illustrates a flowchart of a method for acquiring location information of a ball according to an embodiment.

FIG. 22 illustrates a current frame and surrounding frames in a sports video according to an embodiment.

FIG. 23 illustrates a flowchart of a method for acquiring location information of an object of interest according to an embodiment.

### BEST MODE FOR CARRYING OUT THE INVENTION

A method for collecting ball motion information from a sports video performed on a computing device may include the steps of sequentially receiving each of frames of the sports video as an input image, searching for at least one object classified as a ball in the input image using an artificial intelligence model, classifying the input image as a key frame and determining the object as a ball if there is one object classified as the ball by the artificial intelligence model in the input image and a probability of the object being a ball is greater than or equal to a reference value, determining an alternative region where a ball is expected to be present based on a location of a ball in a surrounding key frame if there is no object classified as the ball by the artificial intelligence model in the input image, determining, if there are a plurality of objects classified as the ball by the artificial intelligence model in the input image, the plurality of objects as candidate regions and classifying the input image as a candidate frame, and determining one of the ball candidate regions of the candidate frame as a ball.

In the step of determining, a candidate region with the highest temporal correlation with the surrounding key frame among the candidate regions may be determined as a ball. The surrounding key frame may be a frame closest to the current frame among key frames located before and after the current frame.

A method for searching for an object of interest in a sports video performed by a computing device may include the steps of receiving a current frame of the sports video, tracking the object of interest in the current frame based on an immediately previous search result if there is the immediately previous search result of the object of interest in an immediately previous frame, searching for the object of interest using an artificial intelligence model if there is no immediately previous search result or if tracking of the object of interest fails, and determining an alternative region where the object of interest is estimated to be located using a frame with a search result among previous frames if searching for the object of interest fails.

A method for collecting location information of an object of interest in a sports video performed on a computing device may include the steps of receiving a current frame of the sports video as an input image, searching for objects of interest in the input image using an artificial intelligence model, assigning label information to at least one of the searched objects of interest, and acquiring two-dimensional location information of the object of interest by perspective transforming location information of the object of interest to which the label information is assigned, in which the object of interest may include a player, a ball, or a referee.

A method for preprocessing a sports video performed on a computing device may include the steps of transforming the sports video into a frequency domain to remove a background region having a frequency component greater than or equal to a reference value, generating a color histogram of a remaining region with the background region removed and determining a color having the largest number of colors based on the color histogram, and extracting a bounding box for pixels having the color, in which the color histogram may be generated by performing K-means clustering on the remaining region to classify pixels constituting the remaining region into a predetermined number of clusters and counting the number of pixels for each of the clusters.

A method for searching for an object of interest in a sports video performed on a computing device may include the steps of searching for objects of interest for a current frame using an artificial intelligence model, determining the current frame as a key frame if there is only one searched object of interest, designating, if there are a plurality of searched objects of interest, each of the searched objects of interest as a first candidate region and a second candidate region and determining the current frame as a candidate frame, determining an alternative region in which the object of interest is expected to be present based on a location of the object of interest in each of surrounding key frames if there is no searched object of interest, and determining a candidate region having a greater temporal correlation with the location of the object of interest in each of the surrounding key frames as the location of the object of interest for the candidate frame.

A method for generating a heatmap of a football game performed on a computing device may include the steps of searching for a ball for a current frame using an artificial intelligence model, recording a location of the searched ball, transforming the recorded location of the ball into a two dimensional plane, and generating a heatmap based on the location of the ball transformed into the two-dimensional plane.

### Mode for Carrying Out the Invention

Below, several embodiments will be described clearly and in detail with reference to the accompanying drawings so that those having ordinary knowledge in the technical field to which the present invention belongs (hereinafter referred to as those skilled in the art) can easily practice the present invention.

Hereinafter, objects of interest may include types of objects that a user may be interested in as objects that constitute a game in a sports video. For example, the objects of interest may include a ball, players, players of a specific team, a specific player, a referee, etc.

Hereinafter, a tracking target is an object that the user is directly interested in among the objects of interest. For example, the user may be interested in motion of a ball and may be interested in motion of a specific player (e.g., player No. 7 or a goalkeeper). Alternatively, the user may be interested in the motion of all objects of interest. Therefore, the tracking target object may be at least one of the objects of interest.

The methods below may be performed on a computing device.

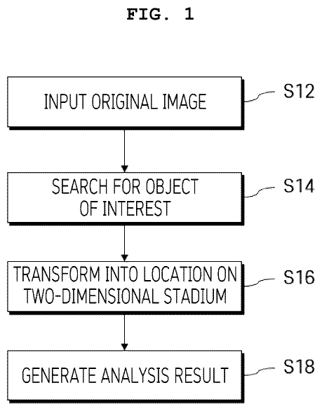

FIG. 1 illustrates a flowchart of a method for motion information of an object of interest in a sports video according to an embodiment.

Referring to FIG. 1, a method for generating motion information of an object of interest in a sports video may include a step of receiving a sports video to be analyzed (S12), a step of searching for an object of interest (S14), a step of transforming location thereof into a location on a two-dimensional stadium (S16), and a step of generating an analysis result (S18).

In step S12, the computing device may receive an original sports video to be analyzed.

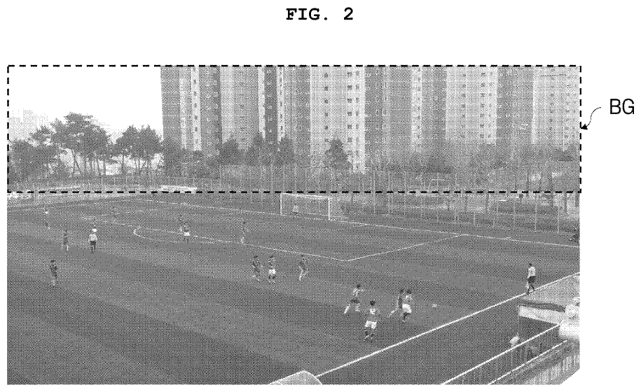

The sports video may include a sports broadcast video, a video filmed with a personal camera, etc. The sports video may include a football video, a futsal video, a basketball video, a rugby video, etc., but is not limited thereto. The sports video may be a video shot with a single camera or a video shot with a plurality of cameras. In the case of a video shot with a single camera, it may be a video shot with a single camera at a fixed location, but is not limited thereto. In the case of a video shot with a plurality of cameras, it may be a video shot with cameras located at different points and combined, but is not limited thereto. The sports video may include a stadium, player(s), and a ball. The sports video input to the computing device in step S12 may be a dynamic video or one (e. g., a frame) of a plurality of static images that constitute the dynamic video. As an example, the computing device may receive an N-th frame (where N is an integer) of a sports video. FIG. 2 illustrates an original image input to the computing device according to an embodiment.

The computing device may preprocess an input image. Preprocessing of the input image is a step of enhancing the image to improve the accuracy of searching for an object of interest. The computing device may perform preprocessing on a current frame. Enhancing the image may include a step of removing the background of the sports video or extracting a region of interest (e. g., a football stadium). Since football videos are usually shot over a wide field and from a distance, the search accuracy can be improved by enhancing the image before searching for an object of interest. For example, background removal may be performed by removing a high-frequency region (e.g., BG in FIG. 2). Extracting a region of interest may be performed by extracting a region whose color is green or similar to green based on a pixel value (e.g., green). Alternatively, a region whose width is greater than or equal to a reference value among flat regions may be extracted as the region of interest. This is because a stadium is generally a wide surface made up of similar colors such as grass, dirt, mats, and courts. According to an embodiment, a region slightly enlarged from the region of interest (e.g., a region enlarged from a bounding box of the region of interest to a reference value) may be determined as an actual region of interest. For example, the actual region of interest may include referees, substitutes, etc. outside the line.

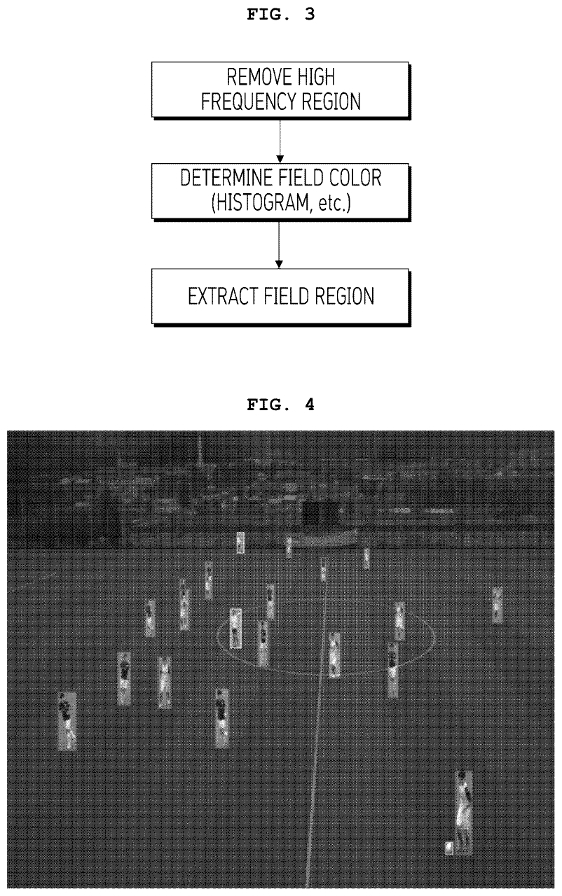

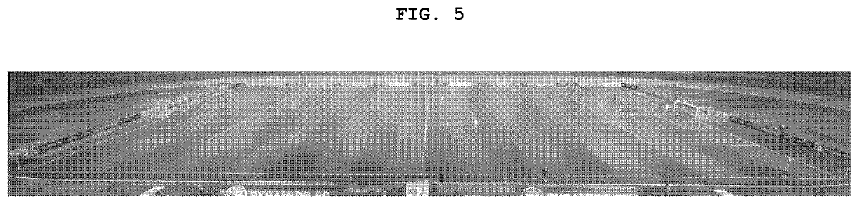

According to an embodiment, a main color (i.e., field color) constituting the region of interest may be determined based on a color histogram of the current image. The computing device may perform color-based clustering on the current input image to classify the current input image into a plurality of color clusters. Similar colors may be classified into one cluster. As a clustering method, K-means clustering technique, etc. may be used, but is not limited thereto. The color belonging to the cluster with the largest number of pixels may be determined as the color of the field region. For example, the main color of a football image may be determined as the color of grass, the main color of a basketball image may be determined as the color of the court (reddish brown, yellow, etc.), and the main color of a tennis image played on a blue court may be determined as blue. A bounding box of pixels belonging to a field color (e.g., the color belonging to the cluster with the largest number of pixels as a result of clustering) may be extracted as the field region. FIG. 3 illustrates a flowchart of a preprocessing method performed on an input image according to an embodiment, but is not limited thereto.

Referring again to FIG. 1, in step S14, the computing device may search for an object of interest in the input image.

The object of interest may include a specific player, players belonging to a specific team, players, a ball, a referee, etc. The computing device may search for objects of interest in the input image using an artificial intelligence model. The artificial intelligence model is intended to identify the objects of interest from a sports video and may be generated by performing learning based on training data. According to an embodiment, the artificial intelligence model may be based on a neural network such as a convolutional neural network (CNN) and may be trained to identify a specific object from a plurality of training images. According to an embodiment, the artificial intelligence model may be trained to identify a player, a ball, etc. from the current image. The artificial intelligence model may be, for example, You Only Look Once (YOLO) or Region with convolutional neural networks (R-CNNs).

According to an embodiment, the artificial intelligence model may search for a player, a referee, and/or a ball from a sports video. FIG. 4 illustrates a state in which an artificial intelligence model searches for objects of interest in a sports video according to an embodiment.

The computing device may search for an object of interest for each frame of an input image or at predetermined intervals. The computing device may determine location information of the searched object of interest. For example, a bounding box including the searched object of interest is drawn, and one of four corners of the bounding box or the center point of the bounding box may be determined as the location of the object of interest.

Referring again to FIG. 1, in steps S16 to S18, the computing device may generate motion analysis information of the object of interest based on the location information of the object of interest.

In step S16, the computing device may transform the location information of the objects of interest acquired in step S14 into location information on a two-dimensional stadium. The location information of the objects of interest acquired in step S14 is usually a three-dimensional stadium view filmed from the front of the stadium (e.g., sideline position), and thus if the location information acquired in step S14 is transformed to a two-dimensional stadium view (i.e., a shape of the stadium viewed from above, see FIG. 6), more accurate object location information may be generated. The computing device may project the location information of the object of interest acquired in step S14 to fit the two-dimensional stadium. The positions of the players and the position of the ball may be known at a glance based on the location information of the two-dimensional image, and thus it is efficient to analyze the results of the game or the motion of the players. Two-dimensional transformation of location information may be performed using perspective transformation. Perspective transformation is a method of mapping by selecting four vertices in a two-dimensional stadium, selecting four points representing the corresponding vertices in the filmed video, expressing how far apart each vertex is by a determinant, and multiplying the matrix by the image.

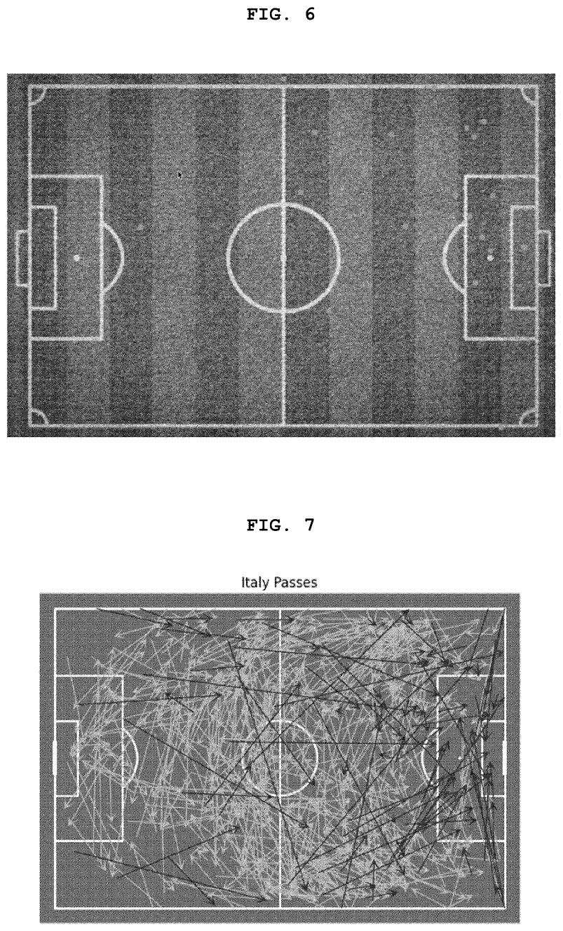

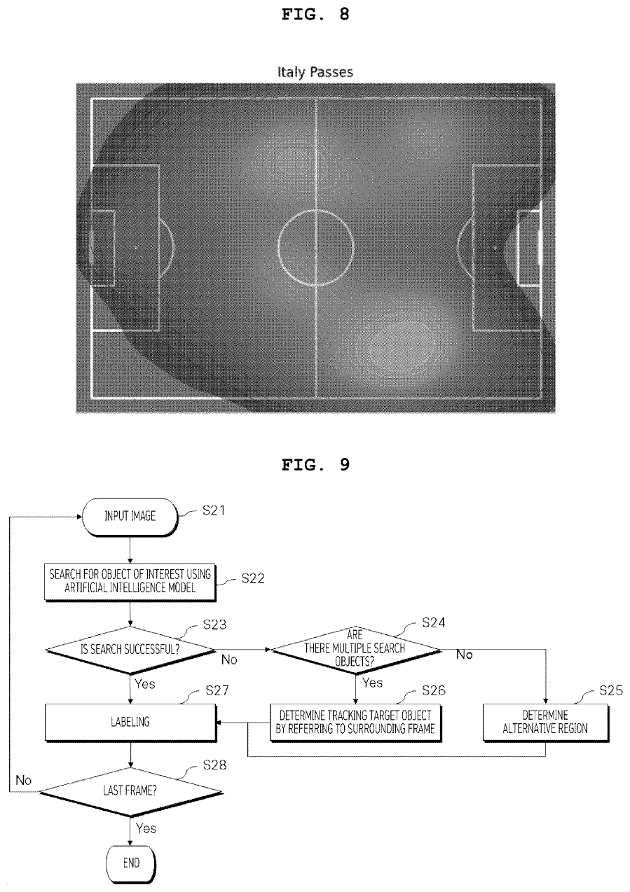

In step S18, the computing device may generate various analysis results based on the location information of step S16. The various analysis results may include the distance moved by players, the motion of a specific player, a heatmap showing the overall motion of a specific player during a game, the motion of a ball, etc. FIG. 7 is a heatmap showing pass information made during a game according to an embodiment, and FIG. 8 is a heatmap showing motion information of at least one player during a game according to an embodiment.

FIG. 9 is a flowchart of a method for searching for an object of interest by a computing device according to an embodiment.

The method of FIG. 9 may correspond to the detailed steps of step S14 of FIG. 1, but is not limited thereto. The method of FIG. 9 may be a flowchart of a method for acquiring motion information of a specific object of interest from a sports video by the computing device.

In step S21, the computing device may receive a sports image. The sports image may be one of the frames constituting a sports video.

In step S22, the computing device may search for an object of interest in the input image.

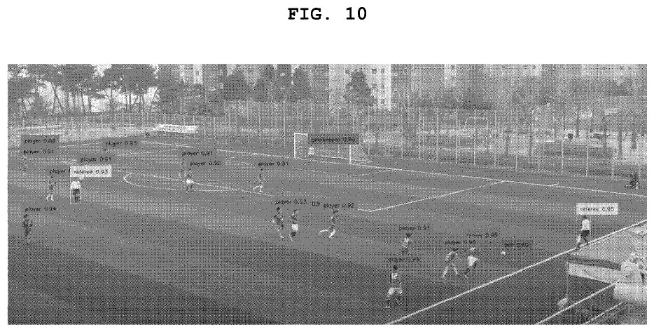

The computing device may search for the object of interest using an artificial intelligence model. According to an embodiment, the artificial intelligence model may be trained to search for a player, a goalkeeper, a referee, and a ball. The artificial intelligence model may determine a type for each of the searched objects and output a probability that each object is of a determined type. FIG. 10 illustrates objects of interest searched by an artificial intelligence model according to an embodiment. For each object of interest, a bounding box is drawn and a probability value is indicated.

In step S23, the computing device may determine whether the object of interest has been searched.

The object of interest in step S23 may mean a tracking target object. For example, a user may want to observe the motion of a ball during a game. Alternatively, a user may want to observe the motion of a specific player (e.g., player No. 7 or a goalkeeper) during a game. Alternatively, a user may want to observe the motion of the specific player and the ball during a game. That is, labeling may be performed on an object whose motion information the user want to know, and the labeled object may be referred to as the tracking target object.

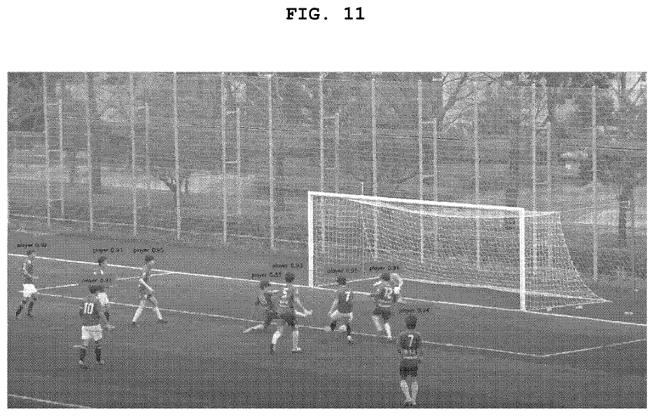

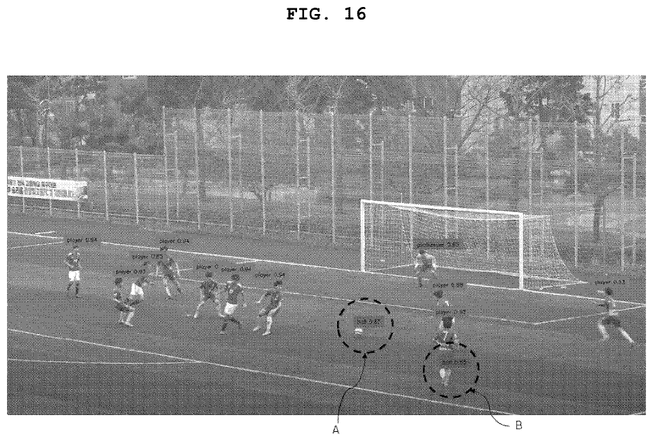

The successful search for the tracking target object may mean that an object classified as the type of the tracking target object is present in the current image and that the probability of it being the type is greater than or equal to a reference value. For example, if the tracking target object is a ball, the ball was searched in the image of FIG. 10 (when the probability reference value is 0.7). The case of failure to search for an object of interest may mean that an object of interest that should be present is not currently searched or that a plurality of objects of interest are searched. In the image of FIG. 11, the ball was not searched. The case where the ball is not searched may include not only the case where the ball itself is not searched, as shown in FIG. 11, but also the case where the probability value is less than the reference value even if an object classified as a ball is present. FIG. 16 shows a state where a plurality of tracking target objects are searched according to an embodiment. If the tracking target object is a ball or a specific player, it is desirable that only one ball or specific player is searched in the image. However, if two or more balls or specific players are searched, only one of the searched objects is the tracking target object we want to track.

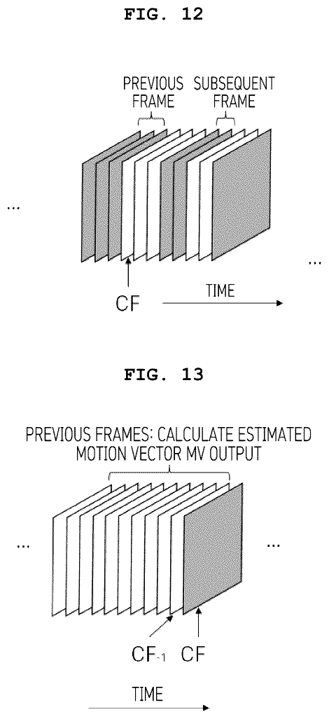

Referring again to FIG. 9, if the search for the object of interest is not successful (No), in step S24, the computing device may determine the type of search failure for the object of interest. First, if the tracking target object is not currently searched (No), in step S25, the computing device may determine an alternative region where the tracking target object is expected to be present. For example, if the original image source is a panoramic image that films the entire football stadium, the ball should be searched. However, the ball may not be searched when the ball is obscured by players, overlaps with other objects, or due to image quality problems, etc. (see FIG. 11). In such a case, the computing device may determine the location of the tracking target object using the search results of surrounding frames. Referring to FIG. 12, the surrounding frames are frames located before or after a current image (CF), and preferably include frames within 10 frames from the current image.

For example, at least one of previous frames in which the ball was searched in the previous frames may be used to determine an alternative region of the tracking target object in the current frame. According to an embodiment, the alternative region of the ball in the current frame may be determined based on a region of the ball in a frame closest to the current frame among the previous frames in which the ball was searched. An area where the ball area of the previous frame is moved by the estimated motion vector may be determined as the alternative region of the ball. An estimated motion vector means the direction and degree in which an tracking target object is expected to have moved between the last frame in which the ball was searched and the current frame. The estimated motion vector may be determined based on at least one previous frame or may be determined based on at least one subsequent frame. The estimated motion vector may be determined based on the previous frame and the subsequent frame. There are various methods for determining an estimated motion vector based on surrounding frames. The estimated motion vector may be determined by averaging it based on the motion of the ball in the previous frames. This is because the time interval between frames is very short (e.g., 1/60 to 1/30 seconds), and thus the possibility of significant deviation from the direction or size of the surrounding motion is small. FIG. 13 illustrates previous frames of a current frame CF for calculating an estimated motion vector.

Location of alternative region=(xₐ+MVₓ, yₐ+MV_{y}) [Equation 1]

In Equation 1, xₐ and yₐ are the positions where the tracking target object was searched in the previous frame where the tracking target object was last searched. MVₓ and MV_{y} are estimated motion vectors where the tracking target object is expected to have moved in the last frame where the tracking target object was searched. The estimated motion vector may be determined based on the motions of the tracking target object in several past frames. For example, when the last frame where the tracking target object was searched is an immediately previous frame, the estimated motion vector may be calculated by averaging the motions of several tracking target objects between the previous frames.

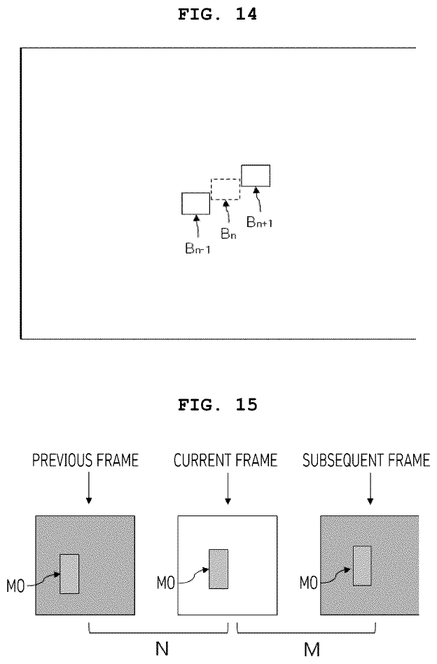

According to an embodiment, the alternative region of the ball in the current frame may be determined based on at least one of the previous frames in which the ball was searched and at least one of the frames after the ball was searched. A region between a region in which the ball was searched in a previous frame and a region in which the ball was searched in a subsequent frame may be determined as the alternative region. Referring to FIG. 14, Bₙ₋₁ is a region in which a ball was searched in a previous frame, Bₙ₊₁ is a region which the ball was searched in a subsequent frame, and Bn is an alternative region in which the ball is expected to be present in the current frame.

In Equation 2, MVₓ and MV_{y} are estimated motion vectors through which the tracking target object is expected to have moved in the last frame in which the tracking target object was searched, and the estimated motion vector may be determined based on a frame closest to the current frame among the previous frames in which the tracking target object was searched and a frame closest to the current frame among the subsequent frames in which the tracking target object was searched. FIG. 15 illustrates a tracking target object (MO) in a previous frame, a current frame, and a subsequent frame according to an embodiment. The previous frame is the frame that is N frames before the current frame, and the subsequent frame is the frame that is M frames after the current frame. In Equation 2, Xa and Ya are the positions where the tracking target object was searched in the previous frame where the tracking target object was last searched.

MVₓ=(x_{b}−xₐ)×N/(N+M), MV_{y}=(y_{b}−yₐ)×N/(N+M) ) [Equation 2]

There may be numerous methods for determining an alternative region of the tracking target object based on the previous and subsequent frames where the tracking target object was actually searched, and thus a detailed description thereof will be omitted.

Referring again to FIG. 9, when a plurality of tracking target objects are searched (Yes), in step S26, the computer device may select one of the plurality of objects as the tracking target object by referring to the surrounding frames. For example, when the tracking target object is a ball, it means a situation where a plurality of objects having a shape similar to a ball are detected within one frame. FIG. 16 illustrates a state in which two balls are detected according to an embodiment. For example, an artificial intelligence model for searching for a ball may search for a plurality of objects determined as balls in the current frame. As an example, object A has a probability of being a ball of 0.67 and object B has a probability of being a ball of 0.55. In this embodiment, if the reference value is 0.5, both objects A and B may be searched for as balls. In this case, one of the plurality of objects A and B needs to be finally determined as the tracking target object.

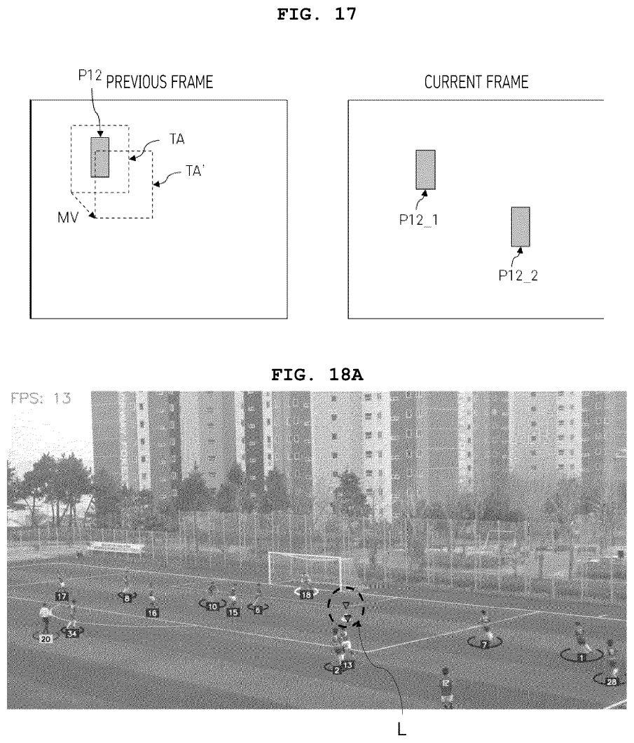

According to an embodiment, an object closest to a location where the estimation target object in the surrounding frame is searched among a plurality of searched objects may be finally determined as the estimation target object. According to an embodiment, an object belonging to a surrounding region of the location where the estimation target object is searched in the surrounding frame among the estimation target objects searched in the current frame may be determined as a final estimation target object. For example, referring to FIG. 17, if the objects searched as the ball in the current frame are P12_1 and P12_2, and a region of the estimation target object in the previous frame is P12_P, P12_1 located in a surrounding region TA of P12_P may be determined as the final estimation target object. The surrounding region TA is not necessarily determined to include the region of the tracking target object in the previous frame. The surrounding region TA may also be determined as a region moved by the estimated motion vector determined from the surrounding frame. Since the method for determining the estimated motion vector is the same as the method described above for determining the alternative region, a detailed description thereof will be omitted. Since it is unlikely that the location of a specific object will change significantly suddenly from the surrounding frame, an object that is far from the surrounding region is likely to be an incorrectly searched object.

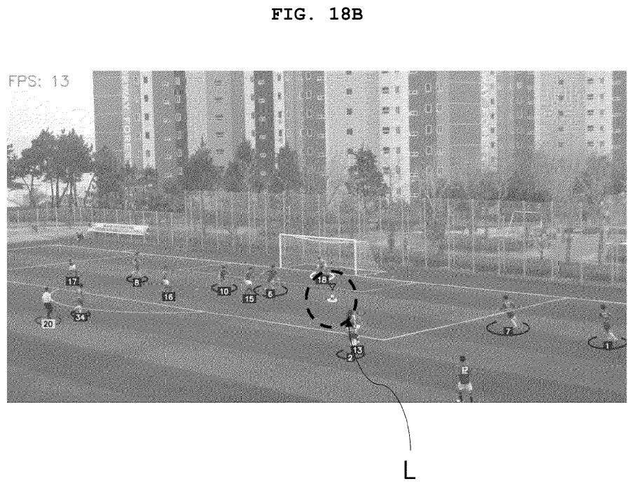

Referring again to FIG. 9, the computing device may perform labeling on the tracking target object determined in step S27. Labeling means assigning identification information to the tracking target object, and the user may effectively visually view the motion of the tracking target object based on the identification information displayed on the screen. In addition, there is an advantage in that the user can determine whether the search for the object of interest in the sports video is being performed well by the computing device labeling. FIG. 18a illustrates a state in which a ball is labeled according to an embodiment, and FIG. 18b illustrates a next frame of the frame of FIG. 18a according to an embodiment. The ball is also labeled in FIG. 18b. The labeling may be performed directly by the user at first (e.g., the first frame in which no labeling information is assigned), but after the tracking target object is labeled, labeling information may be automatically assigned according to object tracking.

FIG. 19 is a flowchart illustrating a method of performing labeling on a searched object by a computing device, according to an embodiment.

In step S191, if the currently input image is the first frame of the original video or there is no other labeling information to refer to (No), the computing device may assign labeling information in step S192. According to an embodiment, labeling may be performed on the tracking target object. For example, labeling may be performed on the ball and/or player No. 7. The labeling information may be assigned by the artificial intelligence model or may be directly input by the user for a specific object. The user may check labeling information assigned by the artificial intelligence model and modify the labeling information. For example, if the artificial intelligence model is trained to search for player No. 7 and the ball in the stadium, the objects searched by the artificial Intelligence model may be assigned ‘7P’and ‘ball’, respectively.

In step S191, if the current frame is not the first frame or there is previous labeling information to refer to (Yes), the computing device may perform object tracking in step S193. Object tracking is to determine whether an object identical to an object assigned a label in a previous frame is present in the current frame, and a conventionally known algorithm (e.g., ByteTrack) may be used for object tracking. If object tracking is successful (Yes), the labeling information of the previous frame may be assigned to the tracking target object of the current frame as well.

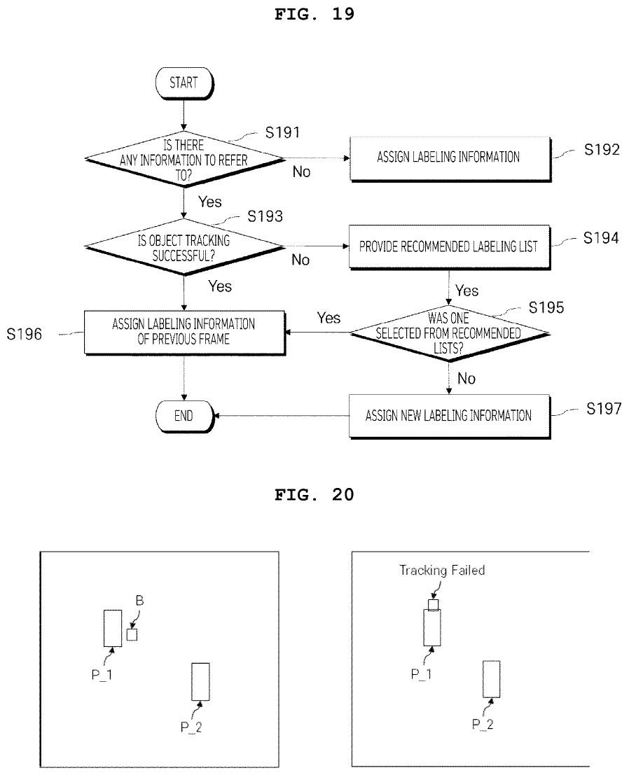

If object tracking fails (No), in step S194, the computing device may provide an object determined not to be present in the current frame among the objects assigned labeling information in the previous frame as a recommended labeling list. Failure in object tracking may mean that the current searched object was not present in the previous frame but newly appeared in the current frame, or that an object in the previous frame corresponding to the currently Searched object is actually present but the corresponding object was not searched for algorithmic reasons. FIG. 20 illustrates a state in which tracking of a labeled object of interest has failed according to an embodiment. For example, the state is a state in which labeling information ‘ball’ was assigned to a ball among the objects of interest in the previous frame and the same ball that was present in the previous frame was searched in the current frame, but was not determined to be the same object for some reason. For example, this may occur due to lighting reasons, changes in shape, appearance, or color as an object moves or rotates, or being obscured by another object or being overlapped with another object. For example, when there were objects labeled ‘7P’ and ‘ball’ in the previous frame, but there is an object assigned labeling information of ‘7P’ in the current frame, but there is no object assigned labeling information ‘ball’, labeling information of ‘ball’ may be recommended as labeling information of the searched tracking target object in the current frame. Alternatively, when there were objects labeled with ‘7P’, ‘referee’, and ‘ball’ in the previous frame, but there is an object assigned labeling information of ‘7P’ in the current frame, but no objects assigned labeling information of ‘referee’ and ‘ball’, labeling information of ‘referee’ and ‘ball’ may be recommended as the labeling information of the searched tracking target object in the current frame.

In step S195, if the user selects one of the recommended lists, labeling information of the previous frame may be assigned. Otherwise (NO), in step S197, the computing device may assign new labeling information by treating it as a newly appeared object in the current frame. The new labeling information may be automatically assigned by the computing device based on the type of the current object of interest or may be received from the user.

Referring again to FIG. 9, in step S28, the computing device may determine whether the current input image is the last frame. If the current input image is not the last frame (No), the computing device may receive the next frame, and if the current input image is the last frame (Yes), the computing device may end searching for the object of interest.

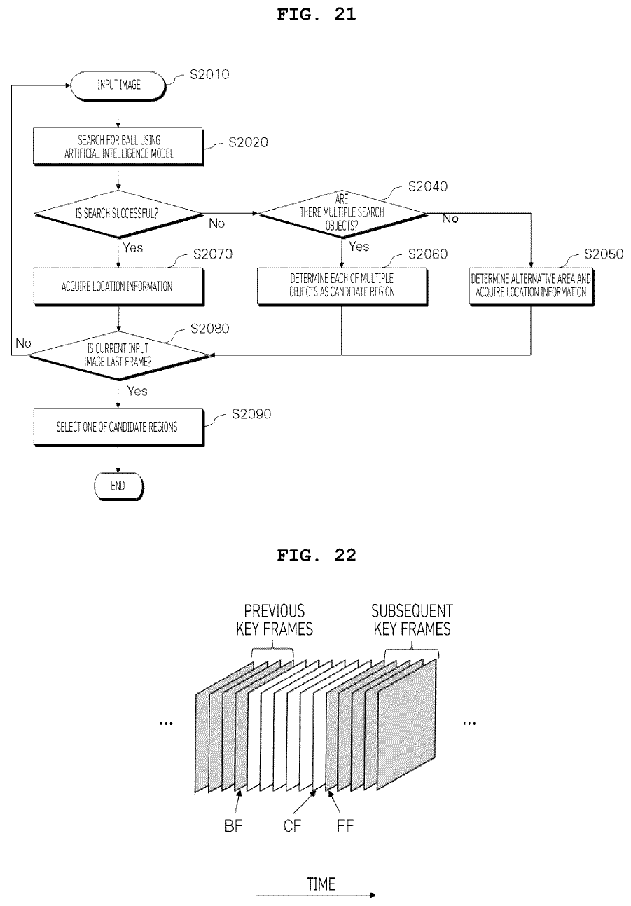

FIG. 21 is a flowchart of a method of acquiring location information of a ball from a sports video by a computing device, according to an embodiment.

In step S2010, the computing device may receive a sports image. The sports image may be one of the frames that constitute a sports video. The computing device may sequentially receive frames that constitute the sports video.

In step S2020, the computing device may search for a ball in the input image using an artificial intelligence model. The artificial intelligence model may be trained to search for a ball. The artificial intelligence model may search for an object determined to be a ball in the input image and output a probability that the searched object is the ball.

If the computing device succeeds in searching (Yes), the computing device may classify the current input image into a key frame and determine the searched object as the ball (step S2070). In step S2070, the computing device may acquire the location of the object determined to be the ball. Successful search may mean that there is one object classified as the ball in the input image and the probability that the object is the ball is greater than or equal to a reference value. The key frame becomes a reference frame for determining a ball region in another frame where ball search fails.

If the computing device fails f in searching (No), the computing device may determine whether there are a plurality of objects classified as balls or there is no object classified as balls. (Step S2040) If there is no object classified as the ball (No), an alternative region where a ball is expected to be present may be determined based on the location of the ball in the surrounding key frame (Step S2050). The computing device may acquire a location of the alternative region. The method for determining the alternative region has been described above with reference to FIGS. 9 to 20.

In step S2060, if there are a plurality of objects classified as balls, the objects classified as balls may be determined as candidate regions and the current input image may be classified as a candidate frame. A situation where there are a plurality of objects classified as balls may be a case where there is an object falsely searched as a ball and/or a case where there are actually a plurality of balls (a new ball situation where a new ball enters the stadium). The computing device may acquire the location of each of the candidate regions.

In step S2080, the computing device may determine whether the current input image is the last frame. If the current input image is not the last frame (No), the computing device may receive the next frame, and if the current input image is the last frame (Yes), the computing device may end searching for the object of interest.

In step S2090, the computing device may determine one of the candidate regions as the ball for each of the candidate frames. The candidate regions may be determined based on the temporal correlation with the object searched as a ball in the surrounding key frames. Since it is unlikely that the direction of movement or size of a specific object in each of the frame images constituting the video will suddenly change significantly, there is a high probability that an object within a range where a specific object is expected to be present is an actual ball even if the frame changes. This is called the temporal correlation, and a high temporal correlation means that when judging by the motion of the ball according to the passage of time when considering the surrounding key frame the corresponding object will move according to the motion of the actual ball of the surrounding key frame and be present at the location of the object when considering the motion of the actual ball of the surrounding key frame ball according to the passage of time. For example, candidate regions that are falsely searched detected as the ball often suddenly appear in locations that are far from the location of the ball in the previous key frame or subsequent key frame. Among the candidate regions, the candidate region with a higher temporal correlation with the key frame may be determined as the final object to be searched (e. g., the ball). This method is also useful when there is an object that was originally searched for as a ball, but a new ball is introduced into the stadium and the search should be done with a new ball instead of the original ball.

According to an embodiment, the surrounding key frame for determining the temporal correlation that is temporally closer to the current candidate frame among an immediately previous key frame and an immediately subsequent key frame may be determined as the key frame. Referring to FIG. 22, an immediately previous key frame BF is the closest frame among the previous key frames of a candidate frame CF, and an immediately subsequent key frame FF is the closest frame among the subsequent key frames of the candidate frame CF. The immediately previous key frame BF is a frame that is six frames away from a candidate frame, and the immediately subsequent key frame FF is a frame that is is one frame away from the candidate frame. In this embodiment, the immediately subsequent key frame FF may be selected as a key frame for calculating the temporal correlation with candidate regions of the candidate frame CF. This is because a frame relatively close to the candidate frame is more accurate for calculating the temporal correlation.

According to an embodiment, a first value, which is a smaller value among a distance between a first candidate region of the candidate frame and a ball location in the immediately previous key frame and a distance between the first candidate region and a ball location in the immediately subsequent key frame, and a second value, which is a smaller value among a distance between a second candidate region and a ball location in the immediately previous key frame and a distance between the second candidate region and a ball location in the immediately subsequent key frame, may be compared, and if the first value is smaller, the temporal correlation of the first candidate region may be determined to be higher. This embodiment places more weight on a physical location of the ball than on a temporal distance between the reference frame and the current frame.

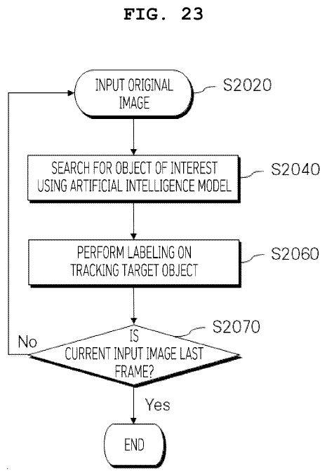

FIG. 23 is a flowchart of a method for searching for an object of interest by a computing device to, according to an embodiment.

In step S2020, an original sports image may be input.

In step S2040, an artificial intelligence model may be used to search for an object of interest.

In step $2060, labeling may be performed on a tracking target object.

In step S2070, the computing device may determine whether the current input image is a last frame. If the current input image is not the last frame (No), the computing device may receive a next frame, and if the current input image is the last frame (Yes), the computing device may end searching for the object of interest.

The above descriptions are intended to provide exemplary configurations and operations for implementing the present invention. The technical idea of the present invention will include not only the embodiments described above, but also implementations that may be obtained by simply changing or modifying the embodiments described above. In addition, the technical idea of the present invention will also include implementations that may be easily achieved by changing or modifying the embodiments described above in the future.

1. A method for collecting ball motion information from a sports video performed on a computing device, the method comprising:
sequentially receiving each of frames of the sports video as an input image;
searching for at least one object classified as a ball in the input image using an artificial intelligence model;
classifying the input image as a key frame and determining the object as a ball if there is one object classified as the ball by the artificial intelligence model in the input image and a probability of the object being a ball is greater than or equal to a reference value;
determining an alternative region where a ball is expected to be located based on a location of a ball in a surrounding key frame if there is no object classified as the ball by the artificial intelligence model in the input image;
determining, if there are a plurality of objects classified as the ball by the artificial intelligence model in the input image, the plurality of objects as candidate regions and classifying the input image as a candidate frame; and
determining one of the ball candidate regions of the candidate frame as a ball, wherein, in the step of determining, a candidate region with the highest temporal correlation with the surrounding key frame among the candidate regions is determined as a ball.
